(19) United States
(12) Patent Application Publication
(10) Pub. No.: US 2020/0230000 A1
(43) Pub. Date: Jul. 23, 2020

(54) Bed Support

(71) Applicant: Guy Wackermann, Monswiller (FR)

(72) Inventor: Guy Wackermann, Monswiller (FR)

(21) Appl. No.: 16/632,208

(22) PCT Filed: Jul. 13, 2018
(86) PCT No.: PCT/EP2018/069090

§ 371 Date: Jan. 17, 2020

(30) Foreign Application Priority Data
Jul. 18, 2017 (FR) 1770769

(51) Int. Cl. A61G 7/00; A61G 7/015; A61G 7/018

(52) U.S. Cl. CPC A61G 7/001; A61G 7/018; A61G 7/015

(57) ABSTRACT

The present invention relates to a bed support comprising a platform (1) and a floating deck (6) each comprising two longitudinal lateral edges, a transverse head edge and a transverse foot edge, said deck (6) being composed of elements (7) connected to each other by articulations (8), and being held above said platform (1) by lifting means (10), characterized in that said lifting means (10) comprise at least two lateral jacks (11) each disposed between a point on one of the lateral edges of the deck (6) and the projection of said point onto the platform (1) in at least one of the lifting configurations.

The present invention also relates to the use of a bed support according to the invention in order to obtain a lateralization or semi-seated position.

The present invention is in the field of medical bedding. It concerns more particularly a bed support comprising an articulated floating deck.

Patients, or bedridden subjects, are sometimes in no condition to turn themselves over. In many cases, this requires the nursing staff itself to turn the patient into a lateral position. However, the fragility of a patient requires special precautions, making this handling difficult, and often requires at least two caregivers. In some cases, the handling is made even more difficult by the fact that any contact with the subject must be avoided. The daily repetition of these manipulations causes health problems for the caregivers.

Document FR 2972628 proposes an articulated bed support that allows patients to be lateralised without effort on the part of the health care staff. However, this support has a fixed central element, which limits the possibilities of movement and does not always allow a complete lateralization of the patient. Furthermore, the fixing of the jacks in the centre of the support does not allow the verticality of a portion of the deck to be achieved.

Other documents, such as US2006/117479, or GB2 345 439 propose beds that are more or less articulated, but always with a fixed portion that limits the flexibility of use of such a bed. As a result, patient mobilization is more limited and certain needs cannot be met.

The purpose of the present invention is to compensate at least in part for these disadvantages by offering a bed support comprising an articulated floating deck, capable of taking different shapes by the action of jacks fixed to a support. For this purpose, it provides a bed support comprising a platform and a floating deck each comprising two longitudinal lateral edges, a transverse head edge and a transverse foot edge, said deck being composed of elements connected to each other by articulations, and being held above said platform by lifting means, characterized in that said lifting means comprise at least two lateral jacks each disposed between a point of one of the lateral edges of the deck and the projection of said point onto the platform in at least one of the lifting configurations.

Thanks to these arrangements, the deck can take different shapes in order, for example, to lateralize the patient, without effort on the part of the health care staff or of the patient himself, and without the need of contact between the staff and the patient. It is also possible to set the bed in a “cradle” position to reduce space requirements.

According to other features:
the bed support may have at least one head jack arranged between the platform and the head edge of the deck, and at least one foot jack arranged between the platform and the deck at the foot edges, in order to allow further movements of the deck, for example to bring the bed into a semi-seated position,
said articulations may be of the type limited to one side only, each articulation between two adjacent elements allowing only one of the two possibilities of an upward movement of at least one of the two adjacent elements relative to the articulation in the resting position of the deck, called receding articulations, or downward movement, called projecting articulations, which allows a simple and inexpensive embodiment of the deck according to the invention, for example by means of articulations,
all longitudinal articulations may be receding, allowing the bed to be moved into a lateral or “cradle” position by lifting push on a single point of the lateral edge of the deck,
at least one row of transverse articulations located towards the head edge may be formed of receding articulations, and at least one row of transverse articulations located towards the foot edge is made of projecting articulations, so that the bed can be brought into a semi-seated position, and in particular a projecting angle can be formed at the patient's legs,
the bed support may have exactly two lateral jacks, one head jack and one or two foot jacks, allowing a single bed to be moved to either a lateral or “cradle” position, or to a semi-seated position by acting on a very small number of actuators.

The present invention also relates to the use of a bed support according to the invention in a medical bed to obtain a lateralization position.

Thanks to these provisions, health care staff can lateralize a patient without any effort, and without effort on the part of the patient. Lateralization can also be performed without contact between the staff and the patient, or can be performed by the patient himself by means of a remote control.

The present invention further concerns the use of a bed support according to the invention in a medical bed to obtain a semi-seated position.

Thanks to these provisions, health care staff can put a patient in a semi-seated position without touching the patient, without any effort, and without effort on the part of the patient.

According to other features:
the foot edge area may be laid flat on one side, and raised on the other side, so that one leg can be raised without raising the other leg, allowing a higher number of possible positions for the patient and better adaptation to his or her particular needs.

The present invention finally concerns a use of a bed support according to the invention in a continuously moving medical bed controlled so as to vary the position of a patient on his mattress.

Thanks to these provisions, certain patients can be set in motion making it possible, for example at night, to ensure that the patient's resting points on his mattress varies, thus making it possible to combat bedsores.

The present invention will be better understood by reading the detailed description which follows, with reference to the joined figures in which:

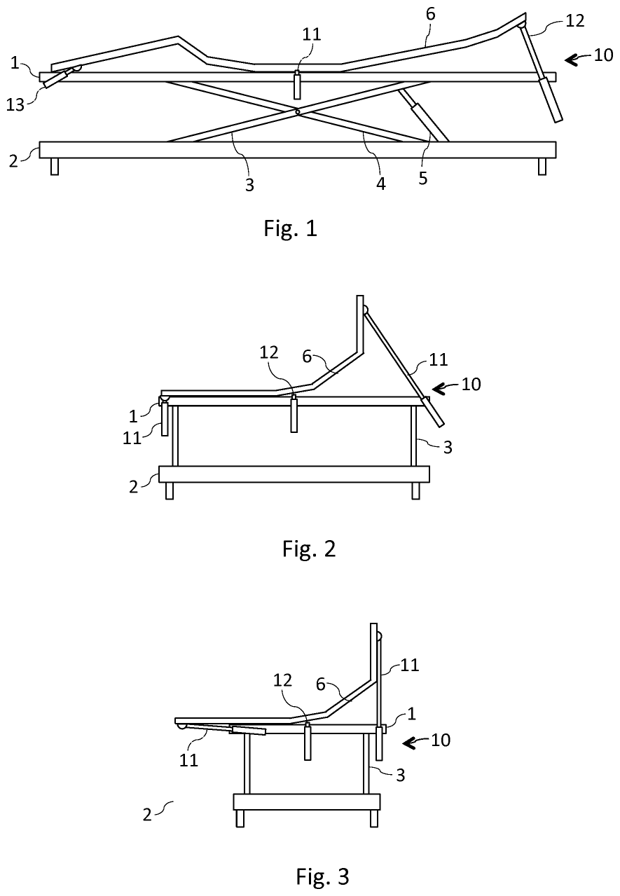

FIG. 1 is a side view of a bed equipped with a bed support according to a first embodiment of the invention, in a semi-seated position,

FIG. 2 is a front view of the bed of FIG. 1, in the lateral position,

FIG. 3 is a front view of a bed equipped with a bed support according to a second embodiment of the invention, in a lateralized position,

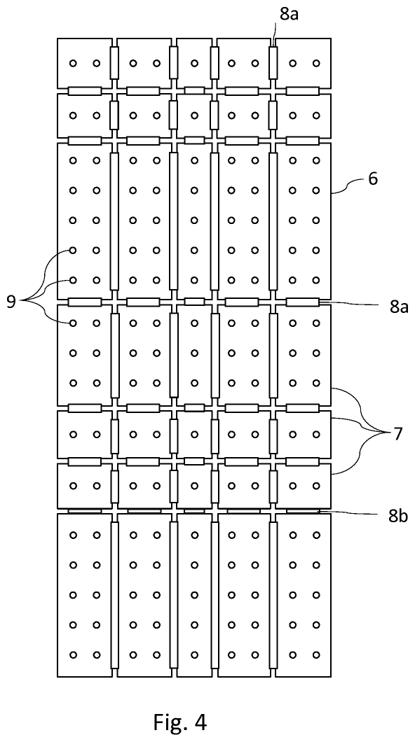

FIG. 4 is a top view of a floating deck according to the invention.

The bed support according to the invention, illustrated in the FIGS. 1 to 4, comprises a platform 1 which can be attached to a medical bed frame 2. In a preferred embodiment of the invention, frame 2 has lifting means 3 for adjusting the height of the bed. As illustrated in FIG. 1, the lifting means 3 may comprise two articulated crosses 4 and one or two jacks 5. The crosses 4 connect the platform 1 to the frame 2 and the jacks 5 allow the angle of the crosses 4, and thus the height of the bed, to be modified. Lifting equipment 3 can also consist of four guided jacks 5 at the four corners of platform 1. This solution also makes it possible, by raising the head jacks more than the foot jacks, to give the platform 1 an inclined shape, and the patient can lie in the bed not horizontally, but with a slight angle relative to the horizontal. In certain indications, especially cardiological ones, such an arrangement is useful. For the same purpose, it can also be provided that platform 1 remains horizontal, for example movable in vertical translation by means of two articulated crosses 4, and that a secondary platform is arranged on platform 1, which can be inclined with respect to platform 1, for example by means of a jack.

The bed support further comprises a floating deck 6, comprising elements 7 connected to each other by means of articulations 8. The articulations 8 may be conventional articulations, or any other type of articulation. Articulations 8 may be limited to movement on one side only. Two types of articulations 8 can then be used: some articulations 8 are limited to an upward movement of one of the two elements 7 which it connects with respect to the resting position of the deck 6; these are called receding articulations 8a. Other articulations 8, on the other hand, are limited to a downward movement of one of the two elements 7 which it connects in relation to the resting position of the deck 6; these are called projecting articulations 8b.

This limitation of the movement of the articulations makes it possible to constrain the deck in such a way as to favour certain movements of the deck.

In the embodiment illustrated in FIG. 4, the deck 6 comprises thirty-five elements 7, seven in the longitudinal direction and five in the transverse direction. Other types of decks can be designed according to the application and the required dimensions. Elements 7 can be provided with ventilation openings 9, allowing ventilation from below of a mattress placed on deck 6.

Deck 6 and platform 1 each have two lateral edges, one foot edge and one head edge. In the following description, the term longitudinal refers to the direction of the lateral edges and the term transverse refers to the direction of the foot and head edges.

Deck 6 is placed on platform 1, and may be lifted above platform 1 by lifting means 10. Deck 6 is floating in the sense that each point of said deck 6 may be lifted in at least one configuration by lifting means 10. The lifting means 10 comprise two lateral jacks 11, each arranged between a point of one of the lateral edges of the deck 6, preferably about the middle of said lateral edge, and the projection of said point onto the platform in at least one of the lifting configurations. According to the needs of the construction, the point of attachment of the lateral jacks 11 may be slightly set back from the lateral edge, by a few centimeters; nevertheless, for the purposes of this invention, it will continue to be considered that the lateral jack 11 is arranged between the lateral edges of the platform 1 and of the deck 6.

The projection may be considered at the resting position of deck 6, as shown in FIG. 2, where the jack is then vertical in the resting position of deck 6, and tilting towards the bed axis during lifting.

The projection may also be considered in the maximum lateralization position of deck 6, as shown in FIG. 3, where the lateral jack 11 is vertical in the maximum lateralization position of deck 6 and almost horizontal in the resting position of deck 6. The width of deck 1 can then be reduced or not, as FIG. 3 shows a reduced deck width.

In a preferred embodiment of the invention, illustrated in FIGS. 1 to 3, the lifting means 10 further comprise a head jack 12, arranged between the head edge of platform 1 and the head edge of deck 6, and a foot jack 13 arranged between deck 1 and deck 6 at their foot edges.

In a preferred embodiment of the invention, all longitudinal articulations 8 are receding articulations 8a. Thus, each lateral jack 11, in combination with the longitudinal receding articulations 8a of the deck 6, makes it possible, as shown in FIGS. 2 and 3, to lateralize the bedridden patient on one side without touching him or her and without effort.

The fact that all the longitudinal articulations are receding makes it possible, for example, to place the deck on a platform that is not as wide as the deck. The impossibility for the longitudinal articulations to protrude ensures that the deck remains perfectly flat, even if one leans on its lateral edge, not directly supported by the platform.

The combined action of the two lateral jacks 11 allows the bed to be placed in a “cradle” position, for example to ensure that the patient is well supported in the bed while the bed is being moved.

The deck 6 according to the invention allows more flexibility than in the state of the art, in which the central longitudinal row of elements 7 is kept horizontal during any lateralization. According to the invention, as illustrated in FIGS. 2 and 3, this central row can be lifted, for example, at one side, or even the entire row, thereby optimizing the lateralization configuration, both (in the case shown in the figs.) lateral rows then optimally accompanying the lateralization movement of the patient by a more pronounced upward movement. Moreover, as the patient lies centered on the bed, being able to lift the central row, the invention allows him to be lateralised without first having to push him laterally towards the raised side. The foot jack 13 and head jack 12 may be programmed to accompany the lifting of the longitudinal centre row of elements 7.

Guides can be added to improve the longitudinal hold of the deck 6. These guides may, for example, consist of a longitudinal guiding of the lateral jacks 11, or of stops at the head and foot edges towards the middle of these edges.

In addition, a guide may be placed at the head and/or foot end of the bed to ensure that the floating deck 6 is given the desired lateralization shape. Such a guide may then form a stop for the head and/or foot edges of the deck 6. The lateral jack 11 then lifts the lateral edge of the deck until the rows of elements rest with their head and foot edges on the guide and the deck is then given the desired shape. The guide may be adapted to the individual patient, in order to give the deck 6 the lateralization shape best suited to the patient's morphology.

Alternatively, or in addition, it may be provided that the lateral jack 11 is only free to rotate about the longitudinal axis of its attachment point to the platform between the resting position and the lateralization position, with a stop that prevents it from going further. As mentioned above, the lateral jack 11 may, for example, be in an inclined position at rest, possibly close to the horizontal, just inclined enough for its actuation to start the lifting movement of the lateral edge of deck 6, and a vertical position at the end of its stroke. In such a configuration, as shown in FIG. 3, it can be foreseen that the platform 1 has a width smaller than that of the deck 6, extending only as far as the attachment points of the lateral jacks 11, the receding articulations 8a guaranteeing the retention of the elements 7 of the longitudinal row of the lateral edge.

Such a configuration gives a particular advantage to the “cradle” position in which deck 6 can be placed. The overall width of the bed is then smaller in the “cradle” position than at rest, and this position allows the bed to go more easily through the doors of the building in which it is located. This is of particular interest when it is desired to use such a bed in the patient's house.

It is also possible to provide that at least one row of transverse articulations 8 located towards the head edge consist of receding articulations 8a, and at least one row of transverse articulations 8 located towards the foot edge consist of projecting articulations 8b. Thus the head jack 12, in combination with the transverse receding articulations 8a of the deck 6, enable the back and head of the bedridden patient to be raised. The foot jack 13, in combination with the transverse protruding articulations 8b of the deck 6, allows to raise one of the knees of the bedridden patient. The foot jack 13 is arranged to exert an upward force on the transverse articulation row 8 at a distance from the foot edge sufficient to lift the articulation row 8. The foot edge of deck 6 then rests on the platform 1 and can slide towards the head edge due to the deformation of deck 6. The combined action of the head jack 12 and foot jack 13 jacks allows the bed to be moved to a “semi-seated” position, as shown in FIG. 1. In a preferred embodiment, all transverse articulation rows 8 from the head edge consist of receding articulations 8a, except for the transverse articulation row 8 closest to the foot edge, which consists of projecting articulations 8b.

According to a particular embodiment, such a semi-seated position can be combined with an inclination of the platform (see above), which could be up to 45°. This results in a sitting position, which can be appreciated especially by elderly people, for example in retirement homes.

In another embodiment of the invention, the bed support has two foot jacks 13. In this case, the deck 6 has longitudinal articulations 8 that can be detached, and it is thus possible to raise the knees of the bedridden patient independently of each other.

A mattress can be placed directly on deck 6. The deck 6 may then comprise stops on its lateral and longitudinal edges to hold the mattress in place, which is particularly important when the deck 6 is set in motion by the lifting means 10.

The bed support according to the invention may be controlled by a memory with a continuous movement program. Thus the bed-ridden patient can be in constant motion without any effort required on the part of the patient or the nursing staff.

In order to facilitate the use of the bed support according to the invention, the lifting means 10, and if necessary the lifting means 3, may be controlled by the nursing staff by means of a remote control.

In such a configuration it can also be the patient himself who operates the remote control, for example to lateralize himself if he does not have the strength to do so with his own muscles.

Although the above description is based on particular embodiments, it is by no means restrictive of the scope of the invention, and modifications may be made, in particular by substitution of technical equivalents or by a different combination of all or part of the characteristics developed above.

1. A bed support comprising a platform (1) and a floating deck (6) each comprising two longitudinal lateral edges, a transverse head edge and a transverse foot edge, said deck (6) being composed of elements (7) connected together by articulations (8), and being held above said platform (1) by lifting means (10), characterized in that said lifting means (10) comprise at least two lateral jacks (11) each disposed between a point on one of the lateral edges of the deck (6) and the projection of said point onto the platform (1) in at least one of the lifting configurations.

2. The bed support of claim 1, comprising at least one head jack (12) arranged between the platform (1) and the head edge of the deck (6), and at least one foot jack (13) arranged between the platform (1) and the deck (6) at the foot edges.

3. The bed support of claim 1, wherein said articulations (8) are of the type limited to one side only, each articulation between two adjacent elements (7) allowing only one of the two possibilities of an upward movement of at least one of the two adjacent elements (7) with respect to the articulation (8) in the resting position of the deck (6), called retracting articulation (8a), or a downward movement, called projecting articulation (8b).

4. The bed support of claim 3, wherein all longitudinal articulations (8) are receding.

5. The bed support of claim 2, wherein at least one row of transverse articulations (8) located towards the head edge consists of receding articulations (8a), and at least one row of transverse articulations (8) located towards the foot edge consists of projecting articulations (8b).

6. The bed support of any of claim 2, having exactly two lateral jacks (11), one head jack (12) and one or two foot jacks (13).

7. Use of the bed support according to claim 1 in a medical bed for obtaining a lateralizing position.

8. Use of the bed support according to claim 2 in a medical bed for obtaining a semi-seated position.

9. Use of a bed support according to claim 8, the foot edge area being flat on one side and raised on the other side so as to enable one leg to be raised without raising the other leg.

10. Use of the bed support according to claim 1 in a continuously moving medical bed controlled so as to vary the position of a patient on his mattress.
